(19) United States
(12) Patent Application Publication
(10) Pub. No.: US 2003/0204323 A1
(43) Pub. Date: Oct. 30, 2003

(54) Membrane moisture measurement

(76) Inventor: Patrick John Morrisey, New Denham Uxbridge (GB)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/239,653

(22) PCT Filed: Mar. 21, 2001
(86) PCT No.: PCT/GB01/01242

(30) Foreign Application Priority Data
Mar. 24, 2002 (GB) 0007286.8

(51) Int. Cl. G01N 31/00

(52) U.S. Cl. 702/27; 702/38

(57) ABSTRACT

A method of measuring the concentration of water in an ion exchange membrane cmprising: (i) measuring the absorbance of electromagnetic radiation transmitted through the membrane, said electromagnetic radiation comprising at least one frequency of an intensity such that it is at least partially, but not entirely, absorbed by water molecules within the membrane; (ii) measuring the thickness of the membrane; and (iii) using the values obtained in (i) and (ii) above to calculate the concentration of water molecules in the membrane.

The present invention is concerned with measuring the moisture content of materials. In particular it is concerned with measuring the moisture content of ion exchange membranes.

Ion exchange membranes are commonly used within many types of electrochemical apparatus such as electrolysers, fuel cells and secondary batteries. The moisture content of an ion exchange membrane is one of its most crucial parameters as it affects its resistivity to the passage of electrical current and its selectivity for particular ions. In general, the higher the moisture content of the membrane the lower is its resistivity to the passage of electrical current. This is advantageous because it reduces energy losses within an electrochemical cell comprising such a membrane. On the other hand, in general, the higher the moisture content the lower the selectivity for particular ions. This is because the higher water content creates a more open membrane structure and the chemical functionality within the membrane, which determines ion selectivity, is accordingly diluted. Thus, it is important that a technique exists for monitoring the water content of such membranes.

A known method of moisture content measurement involves weighing the membrane before and after subjecting it to a drying process. This method suffers from a number of disadvantages. Firstly, the drying process is destructive and thus the membrane sample tested cannot then be used to carry out its intended function. The drying must be aggressive in order to remove all of the water and it results in the membrane turning black. Secondly, the method is not very accurate because the membrane begins to re-absorb water from the air as soon as it is removed from the drying apparatus thus making the dry-weight measurement inaccurate. Thirdly, it cannot guaranteed that all water is removed or that other material is removed during the drying process, making the measurement inaccurate.

These disadvantages are addressed by the present invention which provides a method of measuring the concentration of water in an ion exchange membrane comprising:

(i) measuring the absorbance of electromagnetic radiation transmitted through the membrane, said electromagnetic radiation comprising at least one frequency of an intensity such that it is at least partially, but not entirely, absorbed by water molecules within the membrane,

(ii) measuring the thickness of the membrane, and

(iii) using the values obtained in (i) and (ii) above to calculate the concentration of water molecules in the membrane.

The calculation in step (iii) may be made by application of the Beer-Lambert law. The Beer-Lambert law is well known to those skilled in the art and it may be expressed by the equation:

c=A÷εl

wherein

c=concentration,

A=absorbance,

l=path length (this is equal to the membrane thickness),

ε=extinction coefficient for water measured at the frequency used.

The membrane thickness can be measured by any standard method used for the measurement of the thickness of thin film materials. For instance, the membrane thickness may be measured by use of a thickness gauge.

It is important that the spectroscopic measurement involves transmission of electromagnetic radiation through the entire width of the membrane. This ensures that the measurements are indicative of the properties of the membrane as a whole. Measurement of reflected electromagnetic radiation only provides information about the surface layer of the membrane, i.e. to a depth of approximately 1 μm.

It is also important that the electromagnetic radiation is not entirely absorbed by the water molecules upon transmission through the membrane because this would not provide a true indication of the total water content of the membrane. It is preferable to select electromagnetic radiation of one or more frequencies which is/are absorbed only weakly by water molecules and which is/are not absorbed to a significant extent by other constituents of the membrane.

Preferably, the electromagnetic radiation transmitted through the membrane comprises one or more frequencies in the range of from 4000 to 8000 cm⁻¹, more preferably, from 4600 to 5500 cm⁻¹ and/or 6100 to 7200 cm⁻¹. Most preferably, the electromagnetic radiation transmitted through the membrane is of a frequency of approximately 5200 cm⁻¹ and/or approximately 7000 cm⁻¹.

It will be appreciated by a person skilled in the art that the intensity of electromagnetic radiation used will vary depending upon the strength of absorbance of the water molecules at the chosen frequency. Since the method involves transmission through the material under investigation it is important that the electromagnetic radiation should not be totally absorbed by the material. Thus, if the absorbance at the chosen frequency is strong, the intensity of electromagnetic radiation will need to be higher. However, the intensity which maybe used is obviously limited by the ability of the material to withstand irradiation at high intensity.

It will be appreciated by a person skilled in the art that the present invention may be used to monitor the moisture content of a variety of ion exchange membranes. However, the present invention is particularly concerned with measuring the moisture content of cation selective ion exchange membranes. Cation selective ion exchange membranes are commonly manufactured from polymers or co-polymers which comprise a fluorinated carbon polymer backbone with a plurality of pendant side chains. The pendant side chains may comprise one or more hydrocarbon chains and essentially comprise one or more cation selective functional groups. Although it is preferable that the pendant side chains should comprise one or more hydro carbon chains, this is not an essential feature. For instance, the pendant side chains may comprise hydrocarbon side chains, such as polystyrene.

Such a co-polymer may be, for example, a graft co-polymer comprising a fluorinated carbon polymer backbone, such as polytetrafluoroethylene or polyhexafluoropropylene, with additional monomer units grafted thereon so as to provide the pendant side chains. Said side chains may comprise one or more fluorinated carbon chains and essentially comprise one or more cation selective functional groups. Preferably, such a graft co-polymer may be formed by a process of irradiation grafting.

Such a co-polymer may also be, for example, a statistical, random, alternating or block co-polymer, comprising as monomer units one or more fluorinated alkenes such as tetrafluoroethylene or hexafluoropropylene and one or more fluorinated alkenes which are substituted with pendant side chains. Said side chains may comprise one or more fluorinated carbon chains and essentially comprise one or more cation selective functional groups.

Such cation selective ion exchange membranes commonly utilise sulfonic acid (—SO₂OH) functional groups as the cation selective functional groups. Such membranes are well known in the art. Some examples of commercially available cation selective ion exchange membranes of this type include the Nafion™ range of materials (produced by DuPont), the Flemion™ range of materials (produced by Asahi Glass), the Aciplex™ range of materials (produced by Asahi Chemical) and the Gore Select™ range of materials (produced by Gore).

In a preferred embodiment of the present invention, the method of measuring the absorbance of electromagnetic radiation transmitted through the membrane comprises measuring the peak area of the transmission absorption spectrum over the range of frequencies used.

In a further embodiment, the present invention provides a method of manufacturing an ion exchange membrane including the step of measuring the water concentration of said membrane by a method as herein before described by:

(i) extruding a sulfonyl fluoride precursor material into a film;

(ii) hydrolysing sulfonyl fluoride functional groups to sulfonic acid functional groups, thus converting the film to a membrane; and

(iii) measuring the water concentration of the resultant membrane.

In a still further embodiment, the present invention provides a method of manufacturing an ion exchange membrane including the step of measuring the water concentration of said membrane by a method as hereinbefore described. The ion exchange membrane may be synthesised in many different ways prior to measuring its water concentration, however, a preferred method for the manufacture of a cation exchange membrane comprises the steps of:

(i) providing a film of a fluorinated carbon polymer,

(ii) grafting monomer units which comprise aryl groups to the fluorinated carbon polymer,

(iii) sulfonating one or more of said aryl groups to provide aryl sulfonic acid groups,

(iv) measuring the water concentration of the resultant membrane by a method as hereinbefore described.

The present invention will now be illustrated by way of the following example which is intended to illustrate its application but is not intended to be limiting on its scope.

### EXAMPLE

Specimens of a cation selective ion exchange membrane were prepared from a precursor by the following procedure.

Potassium hydroxide (105 g), dimethylsulfoxide (DMSO, 100 ml) and distilled water (500 ml) were mixed to provide a solution of 3.75M KOH in distilled water with 16.6 volume % DMSO. The solution was placed in a beaker, covered with a watch glass and heated to 75° C. in an oven. A piece of NX115f precursor (60 mm×60 mm×120 μm, manufactured by DuPont) was placed in the solution at 75° C. for 120 minutes. The membrane was then immediately placed in a specimen bottle containing 50 ml of 2M H₂SO₄ where it remained for 24 hours. After quenching in 2M H₂SO₄ the sample was washed with distilled water and cut into approximately 6 equal pieces (3 for mass analysis and 3 for near-infrared spectroscopy analysis). These pieces were stored in distilled water for at least 24 hours prior to analysis. A reaction scheme for the conversion process is shown below:

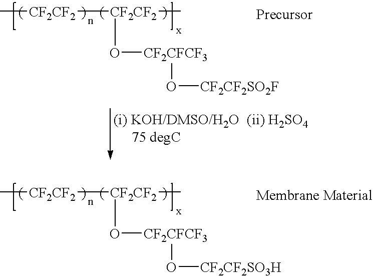

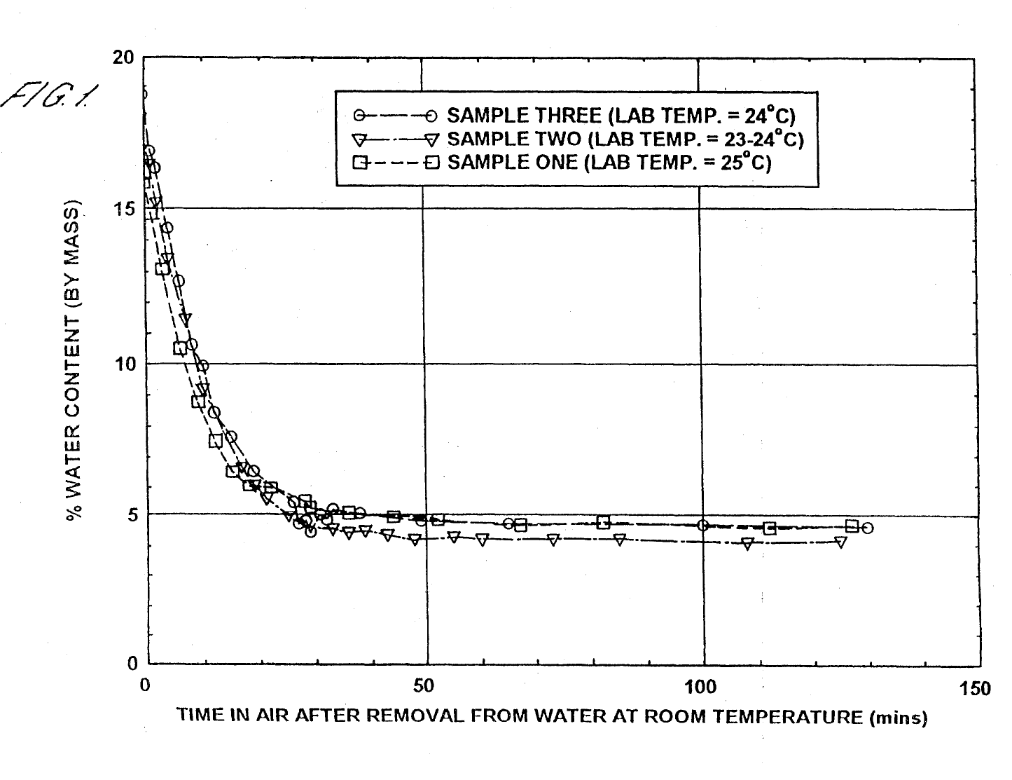

The water content of three of the membrane films was analysed using a Mettler Toledo AG204 analytical balance (resolution=1 mg). Specimens were removed from their storage in water and placed on tissue paper to remove any surface water. They were then immediately placed on the analytical balance and their mass drop monitored as a function of time and temperature as they dried out in air. Samples were then completely dried in an oven at 75° C. for 24 hours in order to determine their percentage water content. FIG. 1 shows the results obtained for the water content of membrane films at the specified room temperatures.

The water content of the other three membrane films was determined by the method of the present invention. Membrane samples were removed from their storage in water, placed on tissue paper to remove any surface water and immediately placed in the spectrometer and acquisition of spectra begun. Near infrared spectroscopy was carried out using a Nicolet Magna FTIR 760 instrument using the following scanning conditions: White light source, KBr beamsplitter, MCT liquid nitrogen cooled detector, wavelength range=8000-4000 cm⁻¹, spectrum resolution=4 cm⁻¹, 16 scans. Spectra were collected at 1 minute intervals for 120 minutes.

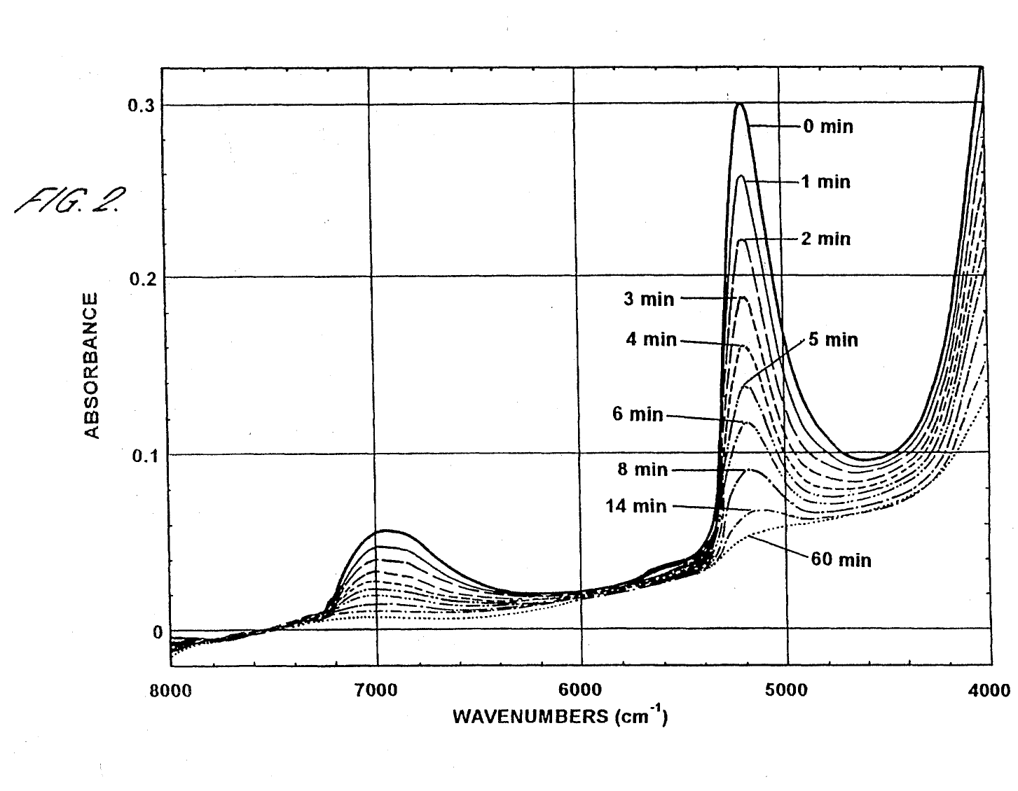

FIG. 2 shows the overlaid spectra that were obtained for one of the three samples. The spectra clearly show changes to the O—H group absorptions at 5194 cm⁻¹ and 6954 cm⁻¹.

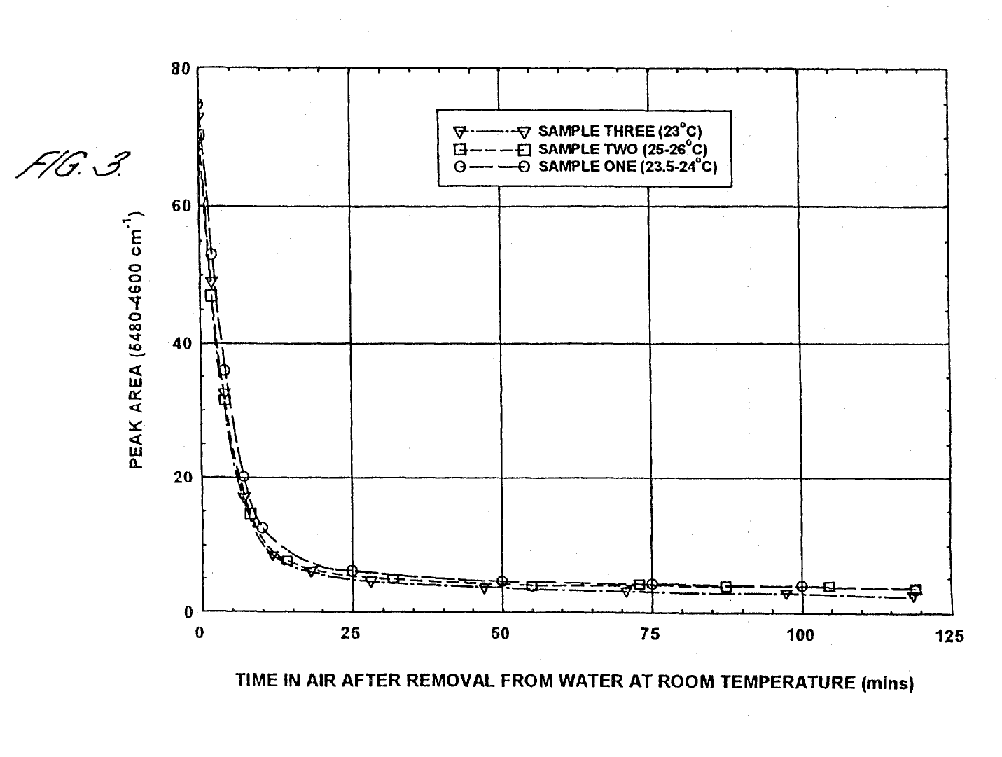

Analysis of the peak area at 5194 cm⁻¹ (using an upper limit of 5480 and a lower limit of 4600 cm⁻¹) versus time was carried out on the three samples analysed. FIG. 3 shows the results of this analysis.

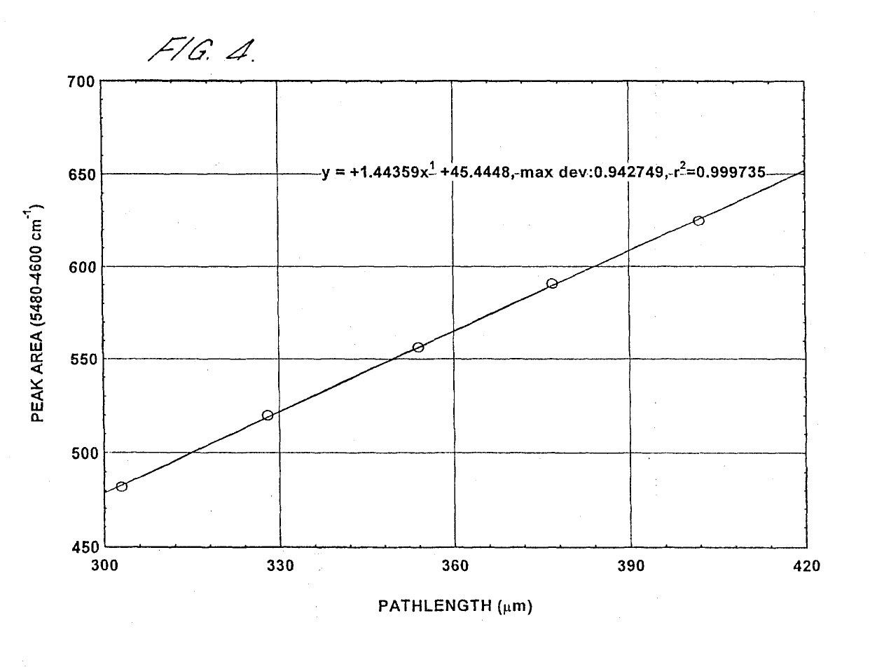

In order to convert the water peak area versus time plot into a percentage water content versus time plot, a number of spectra were recorded of pure water using various path lengths. By applying the Beer Lambert Law (A=εcl) a plot of absorbance (A) for the peak at 5194 cm⁻¹ versus path length (1) gave a straight line with a slope of 1.444. This plot is shown as FIG. 4.

Thus εc=1.44×10⁻⁴ cm⁻¹. Since c for pure water is 1 g/cm³, ε=1.44×10⁻⁴ cm²/g. This value is used to calculate the concentration of water using the equation c=A/εl.

The membrane density was calculated as 1.975 g/cm3. Thus the % water content was calculated using the formula:

% water content=(c/(c+1.975))×100

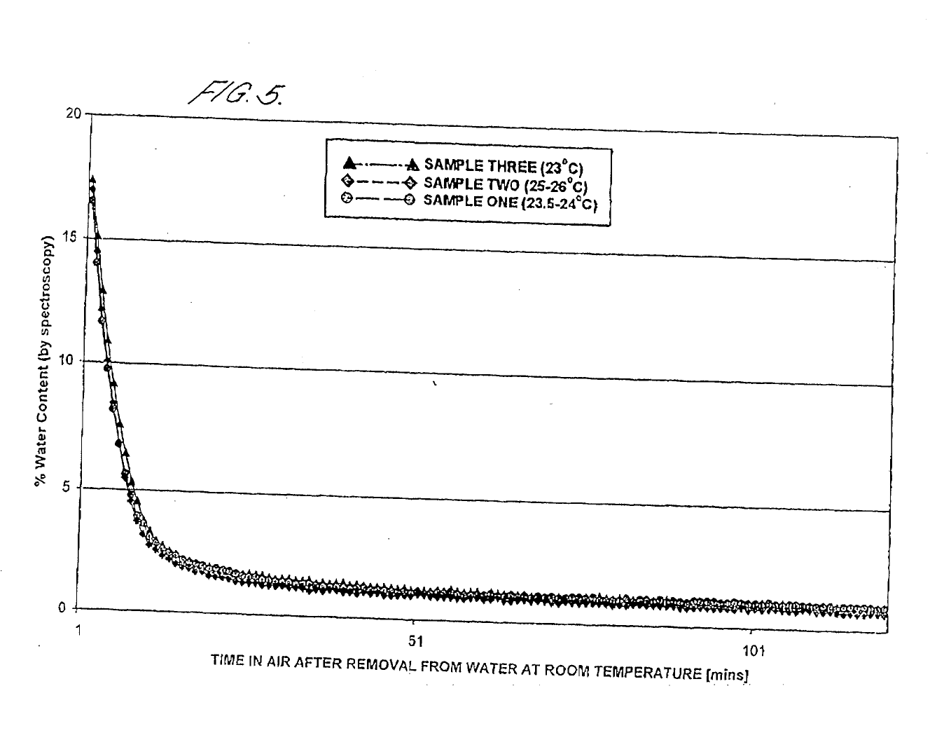

FIG. 5 shows a plot of % water content (as measured by spectroscopy as a function of time). It can be seen that this plot closely resembles that of FIG. 1.

1. A method of measuring the concentration of water in an ion exchange membrane comprising:
(i) measuring the absorbance of electromagnetic radiation transmitted through the membrane, said electromagnetic radiation comprising at least one frequency of an intensity such that it is at least partially, but not entirely, absorbed by water molecules within the membrane,
(ii) measuring the thickness of the membrane, and
(iii) using the values obtained in (i) and (ii) above to calculate the concentration of water molecules in the membrane.

2. A method as claimed in claim 1 wherein said electromagnetic radiation comprises one or more frequencies in the range of from 4000 to 8000 cm⁻¹.

3. A method as claimed in claim 1 or claim 2 wherein the electromagnetic radiation transmitted through the membrane is of a frequency in the range of from 4600 to 5500 cm⁻¹ and/or 6100 to 7200 cm⁻¹.

4. A method as claimed in any one of the preceding claims wherein the electromagnetic radiation transmitted through the membrane is of a frequency of approximately 5200 cm⁻¹ and/or approximately 7000 cm⁻¹.

5. A method according to any one of the preceding claims wherein the ion exchange membrane is a cation selective ion exchange membrane formed from a polymer or copolymer which comprises a fluorinated carbon polymer backbone with a plurality of pendant side chains, said pendant side chains comprising cation selective functional groups.

6. A method according to claim 5 wherein the cation selective functional groups are carboxylic acid groups.

7. A method according to claim 5 wherein the membrane is a bilyar structure with one or more cation selective functional groups.

8. A method according to claim 5 wherein the cation selective functional groups are sulfonic acid groups.

9. A method according to any one of the preceding claims wherein measuring the absorbance of electromagnetic radiation transmitted through the membrane comprises measuring the peak area of the transmission absorption spectrum over the range of frequencies used.

10. A method according to any one of the preceding claims wherein the thickness of the membrane is measured using a thickness gauge.
